(19) United States
(12) Patent Application Publication
(10) Pub. No.: US 2026/0322605 A1
(43) Pub. Date: Oct. 15, 2026

(54) SECURE INTEGER COMPARISON

(71) Applicant: Ava Labs, Inc., New York, NY (US)

(72) Inventors: Furkan Boyraz, Istanbul (TR); Mehmet Berat Öztürk, Istanbul (TR); Emre Kaan Satis, Istanbul (TR); Emin Gün Sirer, Ithaca, NY (US)

(21) Appl. No.: 19/643,324

(22) Filed: Apr. 9, 2026

Related U.S. Application Data
(60) Provisional application No. 63/786,390, filed on Apr. 10, 2025.

(51) Int. Cl. H04L 9/30; H04L 9/00

(52) U.S. Cl. CPC H04L 9/3006; H04L 9/008

(57) ABSTRACT

Various aspects of the subject technology relate to systems and methods for secure comparison of encrypted integers. Aspects may include receiving encrypted integers, each encrypted under a network public key. Aspects may further include obtaining encrypted mask contributions from validators associated with the network public key. Aspects may further include aggregating the encrypted mask contributions to form an aggregated encrypted mask. Aspects may further include performing a homomorphic computation on the encrypted integers and the aggregated encrypted mask to produce an encrypted masked comparison value. Aspects may further include obtaining, from a threshold subset of the validators, a decrypted masked comparison value based on partial decryptions of the encrypted masked comparison value. Aspects may further include generating an encrypted comparison result, encrypted under the network public key, based on the decrypted masked comparison value, and distributing the encrypted comparison result to the validators.

### CROSS-REFERENCE TO RELATED APPLICATIONS

The present disclosure is related and claims priority under 35 U.S.C. § 119(e), to U.S. Provisional Patent Application No. 63/786,390, entitled EFFICIENT SECURE INTEGER COMPARISON, to Furkan Boyraz et al., filed on Apr. 10, 2025, the contents of which are hereby incorporated by reference in their entirety, for all purposes.

### TECHNICAL FIELD

The present disclosure generally relates to cryptographic systems and methods for secure computation on encrypted data, and more particularly to fully homomorphic encryption-based protocols for performing integer comparisons in stateful multiparty environments such as blockchain networks.

### BACKGROUND

Secure computation on encrypted data has become increasingly important in distributed systems where multiple parties must collaborate on computations without revealing private information. Blockchain networks and other decentralized platforms often require the ability to perform operations on encrypted values while maintaining confidentiality throughout the computation process. Integer comparison is a fundamental operation in secure computation that determines the relative ordering of two encrypted values without decrypting them.

Traditional approaches have relied on homomorphic encryption schemes, which support either addition or multiplication operations on encrypted data, but not both. In such approaches, communication complexity typically scales linearly with the number of participating parties, as intermediate results must be processed sequentially by each party. Alternative protocols based on secret sharing achieve better communication complexity but are generally stateless, meaning that comparison outputs cannot be reused in subsequent computations without an additional resharing phase. Additionally, comparison protocols that rely on bitwise decomposition exhibit communication and latency costs that scale with input size. These limitations prevent efficient reuse of encrypted comparison results and hinder integration with systems that maintain persistent encrypted state under a common key, such as confidential smart contracts.

### SUMMARY

Some embodiments of the present disclosure provide a method for secure comparison of encrypted integers in a stateful cryptographic environment. The method includes receiving a first encrypted integer and a second encrypted integer, each encrypted under a network public key. The method further includes obtaining encrypted mask contributions from a set of validators associated with the network public key, wherein each encrypted mask contribution is generated independently by a validator from the set of validators. The method further includes aggregating the encrypted mask contributions to form an aggregated encrypted mask including an encrypted combined coin value and encrypted combined obfuscating values. The method further includes performing a homomorphic computation on the first encrypted integer, the second encrypted integer, and the aggregated encrypted mask to produce an encrypted masked comparison value. The method further includes obtaining, from a threshold subset of the set of validators, a decrypted masked comparison value based on partial decryptions of the encrypted masked comparison value. The method further includes generating an encrypted comparison result, encrypted under the network public key, based on the decrypted masked comparison value and the encrypted combined coin value. The method further includes distributing the encrypted comparison result to the set of validators.

Some embodiments of the present disclosure provide a system for secure comparison of encrypted integers in a stateful cryptographic environment. The system includes a processor and a memory comprising instructions stored thereon, which when executed by the one or more processors, causes the one or more processors to perform some operations. The instructions can configure the processor to receive a first encrypted integer and a second encrypted integer, each encrypted under a network public key. The instructions further configure the processor to obtain encrypted mask contributions from a set of validators associated with the network public key, wherein each encrypted mask contribution is generated independently by a validator from the set of validators. The instructions further configure the processor to aggregate the encrypted mask contributions to form an aggregated encrypted mask including an encrypted combined coin value and encrypted combined obfuscating values. The instructions further configure the processor to perform a homomorphic computation on the first encrypted integer, the second encrypted integer, and the aggregated encrypted mask to produce an encrypted masked comparison value. The instructions further configure the processor to obtain, from a threshold subset of the set of validators, a decrypted masked comparison value based on partial decryptions of the encrypted masked comparison value. The instructions further configure the processor to generate an encrypted comparison result, encrypted under the network public key, based on the decrypted masked comparison value and the encrypted combined coin value. The instructions further configure the processor to distribute the encrypted comparison result to the set of validators.

Some embodiments of the present disclosure provide a non-transitory computer-readable medium storing a program for secure comparison of encrypted integers in a stateful cryptographic environment. The program, when executed by a computer, configures the computer to receive a first encrypted integer and a second encrypted integer, each encrypted under a network public key. The program further configures the computer to obtain encrypted mask contributions from a set of validators associated with the network public key, wherein each encrypted mask contribution is generated independently by a validator from the set of validators. The program further configures the computer to aggregate the encrypted mask contributions to form an aggregated encrypted mask including an encrypted combined coin value and encrypted combined obfuscating values. The program further configures the computer to perform a homomorphic computation on the first encrypted integer, the second encrypted integer, and the aggregated encrypted mask to produce an encrypted masked comparison value. The program further configures the computer to obtain, from a threshold subset of the set of validators, a decrypted masked comparison value based on partial decryptions of the encrypted masked comparison value. The program further configures the computer to generate an encrypted comparison result, encrypted under the network public key, based on the decrypted masked comparison value and the encrypted combined coin value. The program further configures the computer to distribute the encrypted comparison result to the set of validators.

These and other embodiments will become apparent to those of ordinary skill in the art in view of the following detailed description.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a block diagram of a device operating environment with which aspects of the present disclosure can be implemented.

FIG. 2 is a block diagram illustrating details of devices used in the architecture of FIG. 1, according to certain aspects of the present disclosure.

FIG. 3 is a block diagram illustrating a system framework for secure comparison of encrypted values under a secure comparison protocol, according to certain aspects of the present disclosure.

FIG. 4 illustrates a secure comparison system for performing stateful comparison of encrypted integers, according to certain aspects of the present disclosure.

FIG. 5 illustrates a flowchart of an exemplary computer-implemented secure comparison process for performing confidential computation on encrypted data, according to certain aspects of the present disclosure.

FIG. 6 illustrates a method performed by a validator in a stateful cryptographic environment for securely comparing integers, according to certain aspects of the present disclosure.

FIG. 7 is a block diagram illustrating an example computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

### General Overview

Secure computation on encrypted data has emerged as a foundational capability for distributed systems in which multiple parties collaborate on computations without revealing confidential information. In blockchain networks, confidential smart contracts, and other decentralized platforms, the ability to perform operations on encrypted values while maintaining confidentiality throughout the computation process is highly desirable. Integer comparison is a fundamental operation in secure computation that determines the relative ordering of two encrypted values without decrypting them.

Traditional approaches to secure integer comparison have relied on partially homomorphic encryption schemes, which support either addition or multiplication operations on encrypted data, but not both. In such approaches, communication complexity typically scales linearly with the number of participating parties, as intermediate results must be processed sequentially by each party. Alternative protocols based on secret-sharing achieve better communication complexity but are generally stateless, meaning that comparison outputs cannot be reused in subsequent computations without an additional resharing phase. Existing comparison protocols also suffer from scalability limitations when processing large integer values. Protocols that decompose integers into binary representations require communication rounds that scale with the bit-length of the encrypted values, resulting in performance degradation as input sizes increase.

In stateful environments such as confidential smart contracts on blockchains, encrypted state elements must remain encrypted under a consistent public key and be available for subsequent homomorphic operations. Existing comparison methods often fail to meet these requirements, as they either produce unencrypted results or generate outputs under different encryption parameters that cannot be directly combined with existing encrypted state.

The present disclosure addresses these limitations by providing a secure integer comparison protocol that combines fully homomorphic encryption (FHE) with multiparty computation to achieve efficient performance and high security in stateful environments. The comparison protocol operates within a system in which a set of validators holds shares of a secret key corresponding to a single global public key, and state elements are encrypted under that global public key. According to embodiments, validators perform homomorphic operations on ciphertexts to update encrypted state, enabling comparison outputs to be directly reused in subsequent operations without requiring resharing. By leveraging FHE's capability to support both addition and multiplication, the comparison protocol improves the structural efficiency of homomorphic encryption-based solutions while achieving logarithmic communication complexity comparable to that of secret-sharing-based schemes, with reduced data transmission requirements. The disclosed design further enables secure comparison operations whose outputs are directly reusable in subsequent computational steps, thereby eliminating the need for resharing and improving overall efficiency, particularly in stateful blockchain-based applications.

According to embodiments, the comparison protocol employs a mask generation phase in which each validator independently samples random values comprising a coin and two obfuscating numbers, encrypts these values under the network public key, and provides them for aggregation. Because mask generation is independent of the actual comparison inputs, validators can precompute and store masks for future use, decoupling mask generation from the live comparison operation and reducing overall comparison time. This allows all parties to generate and contribute their masks in parallel, as these masks do not rely on inputs from other parties. According to embodiments, the encrypted masks are aggregated locally without inter-party communication, leveraging the support for both homomorphic addition and homomorphic multiplication provided by FHE. This local aggregation eliminates communication overhead and improves robustness, as aggregation can proceed as mask contributions arrive and processing can be initiated once a sufficient threshold of mask contributions has been received.

According to embodiments, the comparison protocol achieves communication complexity independent of the bit length of the compared values and operates in a constant number of communication rounds (for example, two rounds of communication—one for mask transmission and one for decryption). This constant-round behavior is enabled using a FHE scheme that operates on integers rather than binary-decomposed values. In some embodiments, the comparison protocol is implemented in a leader-based model in which a designated leader (for example, a validator designated at random acting as a temporary coordinator for the protocol) performs aggregation and homomorphic computation on behalf of the validators, or in a peer-to-peer model in which each validator performs aggregation and computation internally and validators compare results to confirm correctness.

According to some embodiments, the comparison protocol provides security under a semi-honest adversarial model and can be extended to provide security against malicious adversaries through the use of zero-knowledge proofs or trusted execution environments.

According to embodiments, applications of the comparison protocol include blockchain-based systems. By non-limiting example, the comparison protocol may be implemented in blockchain-based auctions in which encrypted bids are compared while maintaining encryption of bid values. According to embodiments, the disclosed comparison protocol is further applicable beyond blockchain-based systems, including, by way of non-limiting example, cloud computing environments and secure machine learning frameworks, such as federated learning models. In such implementations, the comparison protocol enables efficient and secure comparison of encrypted data across multiple distributed parties without disclosure of underlying plaintext data.

### Example System Architecture

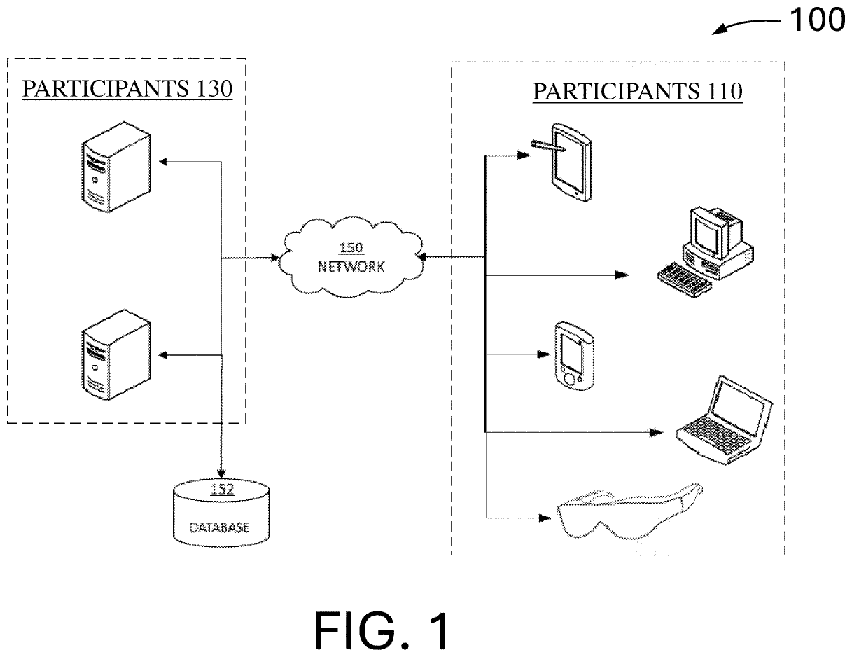

FIG. 1 illustrates a network architecture 100 configured to implement a distributed secure integer comparison protocol that combines fully homomorphic encryption (FHE) with multiparty computation (MPC), enabling efficient and stateful comparison of encrypted values in a blockchain or distributed system, according to some embodiments.

In the example of FIG. 1, the network architecture 100 includes one or more client participants 110 and a plurality of validator participants 130 communicatively coupled through a network 150. The network 150 may include a wired network (e.g., fiber optic or copper wire, telephone lines, etc.) and/or a wireless network (e.g., satellite, cellular, radiofrequency (RF), Wi-Fi, Bluetooth, etc.).

The network 150 may further include one or more of a local area network (LAN), a wide area network (WAN), the Internet, or combinations thereof. Additionally, the network 150 may implement various network topologies, including but not limited to bus, star, ring, or mesh configurations, and may support both peer-to-peer and leader-based communication models for executing the comparison protocol.

Participants 110 may include computing devices such as laptops, desktops, mobile devices, or other systems with sufficient computational and storage resources. In some embodiments, participants 110 function as clients that submit encrypted inputs (e.g., Enc(x) and Enc(y)) under a global public key associated with a distributed FHE scheme. These encrypted inputs correspond to values to be compared, and may represent state variables in confidential smart contracts or other stateful applications.

Participants 130 may be a cloud server or a group of cloud servers. In other embodiments, some or all of the participants 130 may not be cloud-based servers (i.e., may be implemented outside of a cloud computing environment, including but not limited to an on-premises environment), or may be partially cloud-based. Some or all of the participants 130 may be a computing device such as part of a cloud computing server including one or more desktop computers or panels mounted on racks, and/or the like. The panels may include processing boards and also switchboards, routers, and other network devices. In some embodiments, participants 130 may include the participants 110 as well, such that they are peers.

Participants 130 (and optionally participants 110) may function as validator nodes that maintain a distributed ledger and execute the secure comparison protocol over encrypted data. In some embodiments, participants 130 may include validator nodes that collectively execute the secure comparison protocol. In some embodiments, one validator acts as a leader that coordinates execution, while other validators generate and provide encrypted masking components, including random values and sign shares. These masking components may be generated independently of the inputs and preprocessed in advance, enabling reduced online computation latency and parallel contribution from validators. According to some embodiments, validators homomorphically aggregate encrypted masking components (including additive aggregation of random masks and multiplicative aggregation of sign values) and compute an encrypted masked difference between inputs using FHE operations. A threshold subset of validators then participates in a threshold decryption of the masked value, enabling determination of the comparison result without revealing the underlying inputs. The result is re-encoded as an encrypted Boolean value (e.g., Enc([y≥x])) that can be reused in subsequent computations without additional resharing, thereby supporting stateful execution.

Participants 130 may store blockchain and protocol-related data in a peer-to-peer (P2P) and/or distributed database 152. The database 152 may include encrypted input and state values, a global FHE public key, secret key shares for threshold decryption, precomputed encrypted masking values, and logic for performing homomorphic operations and coordinating MPC steps of the comparison protocol. The system may support multiple blockchain instances or subnets, each capable of executing the secure comparison protocol with communication complexity that is independent of the bit length of the compared values and a reduced number of interaction rounds.

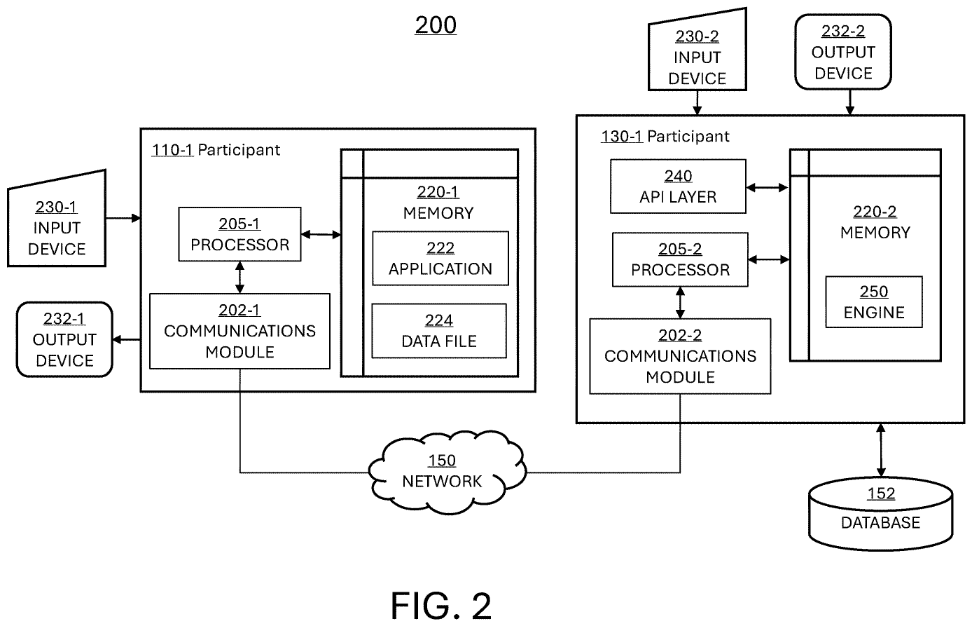

FIG. 2 is a block diagram illustrating details of participants implementing a distributed secure comparison protocol based on fully homomorphic encryption (FHE) and multiparty computation (MPC) in the architecture of FIG. 1, according to some embodiments. Specifically, the example of FIG. 2 illustrates an exemplary participant 110-1 (of the participants 110) and an exemplary participant 130-1 (of the participants 130) of the network architecture 100 of FIG. 1. System 200 is configured to implement blockchain consensus, confidential transaction processing, threshold cryptographic operations, and MPC subroutines in accordance with the FHE-based secure comparison protocol on the network architecture 100.

The participant 110-1 may be a client device and the participant 130-1 may be a validator node. The participant 110-1 and the participant 130-1 may access each other and other participants (for example, validator nodes) in the network 150 via corresponding communications modules 202-1 and 202-2, respectively. For example, participant 110-1 and the participant 130-1 may be connected by wired or wireless means to the Internet and support communication with a blockchain distributed ledger supporting confidential smart contracts and secure comparison operations over encrypted inputs via communications modules 202-1 and 202-2. While certain embodiments are described in the context of a blockchain network, alternative distributed ledger or distributed computing environments may also be used.

The communications modules 202-1 and 202-2 may be, for example, modems or Ethernet cards, and may include radio hardware and software for wireless communications (for example, via electromagnetic radiation, such as radiofrequency (RF), near field communications (NFC), Wi-Fi, and Bluetooth radio technology). The participant 110-1 and participant 130-1 also include a processor 205-1, 205-2 and memory 220-1, 220-2, respectively. Communications modules 202-1 and 202-2, processors 205-1 and 205-2, and memories 220-1 and 220-2 will be collectively referred to, hereinafter, as “communications modules 202,” “processors 205,” and “memories 220.” Processors 205 may be configured to execute instructions stored in memories 220, to cause participant 110-1 and/or participant 130-1 to perform methods and operations consistent with embodiments of the present disclosure including, but not limited to, blockchain setup/initialization, encryption of inputs (e.g., Enc(x), Enc(y)), generation and aggregation of encrypted masking values, homomorphic evaluation of masked comparison functions, threshold decryption, and blockchain state updates.

The participant 110-1 and the participant 130-1 are coupled to at least one input device 230-1 and input device 230-2, respectively (hereinafter, collectively referred to as “input devices 230”). The input devices 230 can include a mouse, a keyboard, a pointer, a stylus, a touchscreen, a microphone, voice recognition software, a joystick, a virtual joystick, a touch-screen display, and the like. The participant 110-1 and the participant 130-1 are also coupled to at least one output device 232-1 and output device 232-2, respectively (hereinafter, collectively referred to as “output devices 232”). The output devices 232 may include a display (for example, a same touchscreen display used as an input device), a speaker, an alarm, and the like. A user may interact (for example, submit encrypted inputs for comparison and receive encrypted comparison results) with participant 110-1 and/or participant 130-1 via the input devices 230 and the output devices 232.

The participant 110-1 can implement and/or manage the blockchain framework described herein by application 222 executing within memory 220-1 and couple with input devices 230 and output devices 232. The application 222 may be downloaded by a user from participant 130-1, and/or may be hosted by participant 130-1. The application 222 includes specific instructions which, when executed by processor 205-1, perform operations consistent with embodiments of the present disclosure. In some embodiments, application 222 runs on an operating system (OS) installed on participant 110-1. In some embodiments, application 222 may run within a web browser, decentralized application (dApp), wallet, finance application, or the like. In some embodiments, the processor 205-1 is configured to control a graphical user interface (GUI) (spanning at least a portion of input devices 230 and output devices 232) for the user of participant 110-1 to access participant 130-1.

Data and files associated with the application 222 may be stored in a local data file 224 stored in memory 220-1, a local database of participant 110-1 or participant 130-1, or an external database (for example, database 152, a distributed database, and the like). The participant 110-1 may be used to perform blockchain-related operations including, without limitation, submission of encrypted inputs for comparison, receipt of encrypted comparison outputs, validation requests, and smart contract interactions.

Participant 130-1 includes an application programming interface (API) layer 240, configured to provide data, instructions, or updates to application 222 in participant 110-1. API layer 240 may facilitate communication between client devices and blockchain services implementing the FHE-based secure comparison protocol. Participant 130-1 may execute validator logic and protocols stored in memory 220-2. In some embodiments, memory 220-2 of participant 130-1 includes a blockchain engine 250 configured to perform operations consistent with embodiments of the present disclosure. The blockchain engine 250 is configured to manage block production, consensus participation, transaction validation, and state transitions. For example, during block building, encrypted inputs may be processed via a comparison module of the blockchain engine 250, which performs masking aggregation, homomorphic comparison computation, and threshold decryption subroutines prior to block finalization to ensure atomic and deterministic state updates across all validators. A user may access the blockchain engine 250 through application 222 executing on participant 110-1.

### Secure Comparison Protocol System

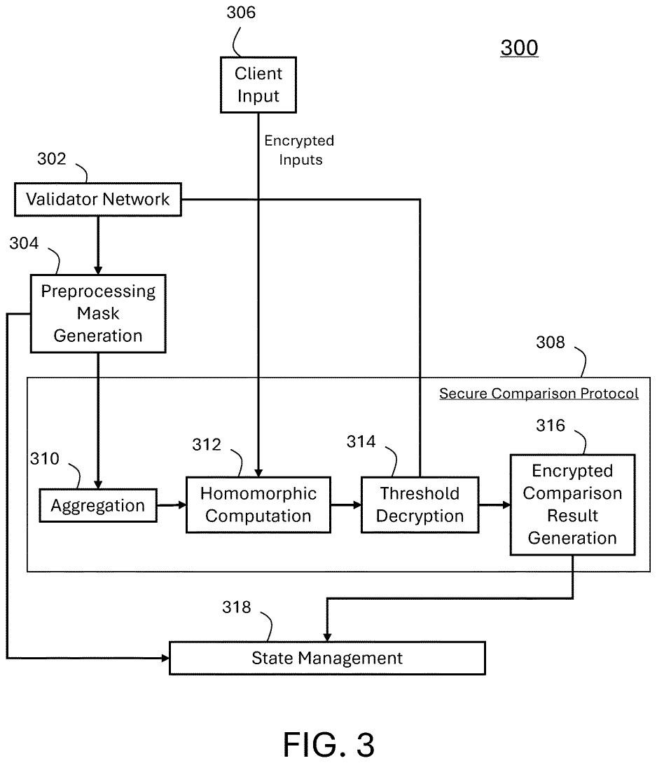

FIG. 3 is a block diagram illustrating a system framework 300 for secure comparison of encrypted values using validator-generated mask contributions, aggregation, homomorphic computation, threshold decryption, and encrypted comparison result generation in a stateful cryptographic environment. System framework 300 includes a validator network 302, preprocessing mask generation 304, client input 306, and a secure comparison protocol 308 further including aggregation 310, homomorphic computation 312, threshold decryption 314, and encrypted comparison result generation 316, and state management 318.

The validator network 302 includes validators configured to participate in the secure comparison protocol. The validators of the validator network 302 hold secret-key shares associated with a global public key (also referred to as a network public key). The global public key may be used to encrypt comparison inputs, encrypted mask contributions, encrypted intermediate values, encrypted state elements, and encrypted comparison results. The validators are further configured to generate partial decryptions for recovery of a decrypted masked comparison value. In some embodiments, the validator network 302 is configured to participate in t-of-N threshold decryption using encrypted mask contributions and partial decryptions from a threshold subset of validators without requiring participation of all validators.

In some embodiments, the validator network 302 may be implemented as a blockchain validator network, a distributed computing network, a confidential smart-contract network, or another distributed cryptographic network configured to maintain encrypted state under the global public key.

In some embodiments, the secure comparison protocol 308 operates according to a leader-based model in which a designated validator coordinates receipt of encrypted inputs, aggregation of encrypted mask contributions, homomorphic computation, receipt of partial decryptions, and generation or distribution of an encrypted comparison result. As used herein, a “leader” refers to a computing node, such as a validator, that is designated for a given protocol instance, round, block, or time interval to coordinate execution of the secure comparison protocol. The leader may receive or access encrypted input values, collect encrypted mask contributions from other participating nodes, aggregate the encrypted mask contributions, perform one or more homomorphic computations based on the aggregated contributions and the encrypted input values, initiate threshold decryption of an intermediate ciphertext, and generate or distribute an encrypted comparison result. The leader need not possess the complete secret key and need not perform decryption alone. As used herein, a “leader-based model” refers to an execution model in which one participating node is designated as the leader for a given protocol instance and performs coordination operations on behalf of multiple participating nodes. In a leader-based model, other nodes may generate and provide encrypted mask values or partial decryptions, while the leader performs aggregation and comparison-related homomorphic processing. The designation of the leader may be fixed, rotating, randomly selected, selected according to a blockchain consensus mechanism, or otherwise determined.

In some embodiments, the validator network 302 operates according to a peer-to-peer model in which multiple validators receive encrypted mask contributions, locally perform aggregation and homomorphic computation, and compare resulting outputs for consistency—distributing operations across multiple nodes.

The preprocessing mask generation 304 generates encrypted mask contributions independently of encrypted comparison inputs. In some embodiments, respective validators independently generate corresponding encrypted mask contributions, each encrypted under the global public key. Accordingly, the encrypted mask contributions may be precomputed and made available for later comparison operations. In some embodiments, each encrypted mask contribution includes an encrypted coin corresponding to a coin value sampled from a set consisting of negative one and positive one, a first encrypted obfuscating number, and a second encrypted obfuscating number. The first and second obfuscating numbers may comprise random values selected to mask a later comparison computation. Because generation of the encrypted mask contributions is independent of the encrypted comparison inputs, the encrypted mask contributions may be generated before receipt of the encrypted comparison inputs and stored for later use, such as in a state management component or other storage location accessible during a subsequent comparison operation. In some embodiments, the encrypted mask contributions are generated in parallel by multiple validators, thereby reducing latency of a live comparison operation.

The client input 306 provides encrypted comparison inputs to the secure comparison protocol 308. In some embodiments, the encrypted comparison inputs include a first encrypted integer and a second encrypted integer, each encrypted under the global public key. The encrypted comparison inputs may be received from one or more users, applications, smart contracts, or other computing entities and may correspond to integer values to be compared without revealing plaintext values. In some embodiments, the encrypted comparison inputs are generated by encrypting respective plaintext integers under the global public key before submission to the secure comparison protocol 308. In some embodiments, the encrypted comparison inputs are provided to a designated leader validator. In other embodiments, the encrypted comparison inputs are made available to multiple validators for use in a peer-to-peer execution model.

The aggregation 310 aggregates the encrypted mask contributions. In some embodiments, the encrypted mask contributions include encrypted coin values and encrypted obfuscating values generated by respective validators under the global public key. In some embodiments, the encrypted coin values are combined multiplicatively to form an encrypted combined coin value, first encrypted obfuscating numbers are combined additively to form a first encrypted combined obfuscating value, and second encrypted obfuscating numbers are combined additively to form a second encrypted combined obfuscating value. Because the secure comparison protocol 308 employs an encryption scheme supporting both homomorphic multiplication and homomorphic addition (for example, FHE), the aggregation 310 may locally aggregate the encrypted mask contributions without requiring sequential processing of plaintext intermediate values by multiple validators. In some embodiments, aggregation is performed by a designated leader validator. In other embodiments, multiple validators perform corresponding aggregation operations locally in a peer-to-peer execution model. In some embodiments, the aggregation 310 proceeds after receipt of encrypted mask contributions from a threshold subset of validators, rather than awaiting contributions from all validators.

The homomorphic computation 312 generates an encrypted masked comparison value based on the first encrypted integer, the second encrypted integer, and the aggregated encrypted mask. In some embodiments, the homomorphic computation 312 includes first computing a shifted encrypted difference between the second encrypted integer and the first encrypted integer. In some embodiments, the shifted encrypted difference can be generated by applying a linear transformation in the encrypted domain. The linear transformation can include multiplying an encrypted difference between the second encrypted integer and the first encrypted integer by a constant and incrementing the resulting encrypted product. The encrypted masked comparison value is then generated based on the shifted encrypted difference, the first encrypted combined obfuscating value, the second encrypted combined obfuscating value, and the encrypted combined coin value. In some embodiments, the homomorphic computation 312 multiplies the shifted encrypted difference by the first encrypted combined obfuscating value and the encrypted combined coin value, and subtracts the second encrypted combined obfuscating value from the resulting encrypted product to produce the encrypted masked comparison value.

In some embodiments, the encrypted masked comparison value corresponds to a masked form of a comparison quantity whose sign indicates whether the second encrypted integer is greater than or equal to the first encrypted integer, while concealing the sign and magnitude of the underlying unmasked difference. The first encrypted combined obfuscating value and the second encrypted combined obfuscating value provide multiplicative and additive masking, respectively, and the encrypted combined coin value provides sign masking. In some embodiments, homomorphic computation 312 is performed locally after receipt of the encrypted comparison inputs and the aggregated encrypted mask, thereby reducing inter-party communication during live comparison processing. In some embodiments, the homomorphic computation 312 is performed under the same global public key as the encrypted comparison inputs such that subsequent output values remain compatible with later encrypted computations in the stateful cryptographic environment.

The threshold decryption 314 obtains a decrypted masked comparison value from the encrypted masked comparison value using distributed validator threshold decryption. In some embodiments, a threshold subset of validators in the validator network 302 generates partial decryptions of the encrypted masked comparison value, and the partial decryptions are combined to obtain the decrypted masked comparison value. In some embodiments, the threshold subset comprises fewer than all validators and may correspond to a majority threshold or another selected t-of-N threshold. In a leader-based embodiment, a designated leader validator receives the partial decryptions from the threshold subset and combines the partial decryptions to recover the decrypted masked comparison value. In a peer-to-peer embodiment, multiple validators may separately receive or derive corresponding partial decryptions and perform corresponding combination operations locally. In some embodiments, the decrypted masked comparison value does not reveal the underlying comparison inputs because the encrypted masked comparison value remains protected by the aggregated masking values prior to decryption.

The encrypted comparison result generation 316 generates an encrypted comparison result based on the decrypted masked comparison value. In some embodiments, the decrypted masked comparison value is evaluated to determine a sign of the decrypted masked comparison value, an intermediate encrypted value is selected based on the sign, and the encrypted comparison result is computed under the global public key based on the intermediate encrypted value and the encrypted combined coin value. The encrypted comparison result remains encrypted under the global public key for reuse in subsequent encrypted computations.

The state management 318 stores encrypted state information associated with the secure comparison protocol. In some embodiments, state management 318 stores precomputed encrypted mask contributions and encrypted comparison results so that encrypted outputs of one operation may be reused in subsequent encrypted operations.

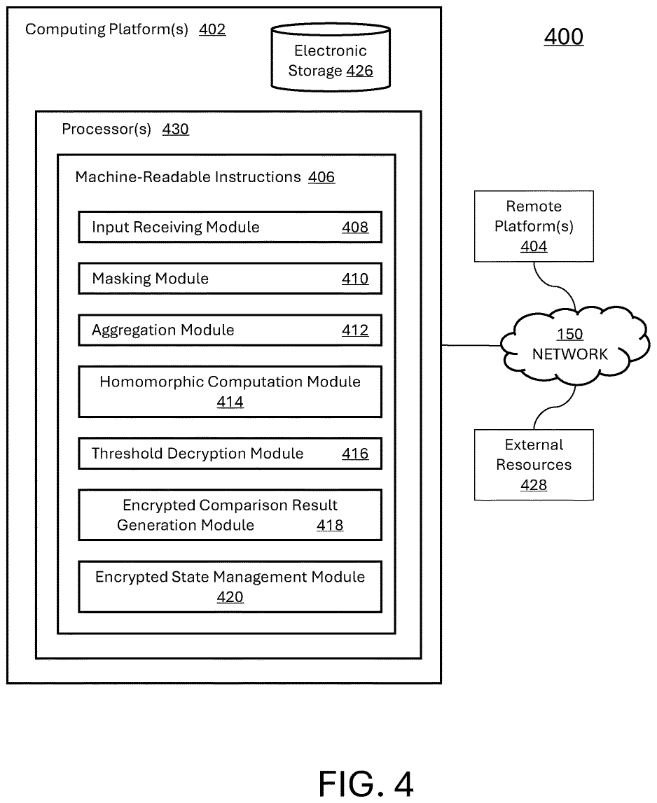

FIG. 4 is a block diagram illustrating a secure comparison system 400 for performing stateful comparison of encrypted integers, according to one or more embodiments. System 400 may be implemented in a distributed cryptographic environment, such as a blockchain validator network, in which a plurality of validators collectively hold secret-key shares corresponding to a network public key and maintain encrypted state under the network public key.

In some embodiments, system 400 is implemented by one or more computing platforms, such as validator machines or execution environments, executing a secure comparison program as part of transaction validation, smart-contract execution, or protocol-integrated cryptographic services. The secure comparison system 400 may operate in a leader-based execution model or a peer-to-peer execution model, as described herein.

In some implementations, system 400 may include one or more computing platforms 402 executing various aspects of the system. The computing platform(s) 402 may correspond to validator machines, blockchain nodes, execution engines, or native verification environments responsible for transaction validation, cryptographic protocol execution, and state updates, which can be similar to or the same as the computing device(s) of participants 130 of FIG. 1 and include the client computing device(s) of participants 110 of FIG. 1 and include the processors 205 in FIG. 2.

Computing platform(s) 402 may be configured to communicate with one or more remote platforms 404 according to a client/server architecture, a peer-to-peer architecture, and/or other distributed communication architectures. The remote platform(s) 404 may be configured to communicate with other remote platforms via computing platform(s) 402 and/or according to a client/server architecture, a peer-to-peer architecture, and/or other architectures. The remote platform(s) 404 can be configured to cause output of the system 400 on client device(s) of the remote platform(s) 404 with enabled access according to stored data. In some embodiments, the remote platform(s) 404 correspond to other validator machines executing instances of the DHE program. Communication among the computing platform(s) 402 and remote platform(s) 404 enables execution of multiparty computation protocols among validators participating in the DHE protocol. The computing platform(s) 402, external resources 428, and remote platform(s) 404 may be in communication and/or mutually accessible via the network 150.

The computing platform(s) 402 may be configured by machine-readable instructions 406. The machine-readable instructions 406 may be executed by the computing platform(s) to implement one or more instruction modules. The instruction modules may include computer program modules. The instruction modules being implemented may include one or more of an input receiving module 408, a masking module 410, aggregation module 412, a homomorphic computation module 414, a threshold decryption module 416, an encrypted comparison result generation module 418, and an encrypted state management module 420. Execution of the machine-readable instructions 406 causes the computing platform(s) 402 to perform the DHE protocol in coordination with blockchain transaction execution, thereby enabling confidential computation over encrypted data while preserving blockchain verifiability.

The input receiving module 408 is configured to receive encrypted comparison inputs, including a first encrypted integer and a second encrypted integer, each encrypted under the network public key. In some embodiments, the encrypted comparison inputs are received from a client device, a smart contract, or another system component. The encrypted comparison inputs may correspond to encrypted state variables maintained by the distributed system, user-submitted encrypted values, bids, balances, counters, or other encrypted integer values to be compared without revealing corresponding plaintext values.

The masking module 410 is configured to obtain a plurality of encrypted mask contributions generated independently by validators associated with the network public key. In some embodiments, each encrypted mask contribution includes an encrypted coin value corresponding to a coin sampled from a set consisting of negative one and positive one, a first encrypted obfuscating value, and a second encrypted obfuscating value. The encrypted mask contributions may be generated independently of the encrypted comparison inputs and may be precomputed and stored prior to receipt of the encrypted comparison inputs for later use in comparison operations.

The aggregation module 412 is configured to aggregate the plurality of encrypted mask contributions to form an aggregated encrypted mask. In some embodiments, the aggregation includes multiplicatively combining encrypted coin values to generate an encrypted combined coin value, additively combining first encrypted obfuscating values to generate a first encrypted combined obfuscating value, and additively combining second encrypted obfuscating values to generate a second encrypted combined obfuscating value. In some embodiments, aggregation may be performed after receipt of encrypted mask contributions from a threshold subset of validators.

The homomorphic computation module 414 is configured to perform a homomorphic computation on the first encrypted integer, the second encrypted integer, and the aggregated encrypted mask to produce an encrypted masked comparison value. In some embodiments, the homomorphic computation includes computing a shifted encrypted difference between the second encrypted integer and the first encrypted integer. In some embodiments, computing a shifted encrypted difference includes multiplying an encrypted difference between the second encrypted integer and the first encrypted integer by a constant and incrementing a first resulting encrypted product. In some embodiments, the homomorphic computation can further include multiplying the shifted encrypted difference by the first encrypted combined obfuscating value and the encrypted combined coin value, and subtracting the second encrypted combined obfuscating value from a second resulting encrypted product to produce the encrypted masked comparison value. The homomorphic computation is performed under the network public key and, in some embodiments, uses an encryption scheme supporting both homomorphic addition and homomorphic multiplication (for example, FHE).

The threshold decryption module 416 is configured to obtain a decrypted masked comparison value from the encrypted masked comparison value. In some embodiments, the threshold decryption module 416 receives, from a threshold subset of validators associated with the network public key, partial decryptions of the encrypted masked comparison value and combines the partial decryptions to recover the decrypted masked comparison value without revealing the underlying comparison inputs. In some embodiments, a designated leader initiates the threshold decryption process, receives the partial decryptions, and combines the partial decryptions to obtain the decrypted masked comparison value. In some embodiments, the encrypted masked comparison value is distributed to validators participating in the threshold decryption process.

The encrypted comparison result generation module 418 is configured to generate an encrypted comparison result based on the decrypted masked comparison value. In some embodiments, the encrypted comparison result is an encrypted Boolean value indicating whether the second encrypted integer is greater than or equal to the first encrypted integer or the second encrypted integer is less than the first encrypted integer. In some embodiments, the encrypted comparison result generation module 418 selects an intermediate encrypted value based on a sign of the decrypted masked comparison value. For example, if the decrypted masked comparison value is greater than zero, the intermediate encrypted value is set to the encrypted combined coin value, and if the decrypted masked comparison value is less than zero, the intermediate encrypted value is set to the additive inverse of the encrypted combined coin value. In some embodiments, the encrypted comparison result is computed based on the intermediate encrypted value and a quantity derived from the encrypted combined coin value.

The encrypted comparison result remains encrypted under the network public key and is suitable for reuse in subsequent encrypted computations without resharing. In some embodiments, the encrypted comparison result is distributed to validator nodes for subsequent validation, storage, or encrypted state updates.

The encrypted state management module 420 is configured to store and manage encrypted state associated with the secure comparison system 400. In some embodiments, the encrypted state includes encrypted comparison results, precomputed encrypted mask contributions, encrypted intermediate values, and other ciphertexts maintained under the network public key. The encrypted state management module 420 enables stateful execution of secure comparison operations across multiple transactions, blocks, or computation rounds.

Collectively, the modules of system 400 implement a secure comparison protocol that enables efficient comparison of encrypted integers in a distributed environment while preserving confidentiality, verifiability, and compatibility with stateful encrypted computation. In some embodiments, the secure comparison protocol uses a constant number of communication rounds independent of a bit-length of the encrypted integers being compared.

In some implementations, the computing platform(s) 402, the remote platform(s) 404, and/or the external resources 428 may be operatively linked via one or more electronic communication links. For example, such electronic communication links may be established, at least in part, via the network 150 such as the Internet and/or other networks. It will be appreciated that this is not intended to be limiting, and that the scope of this disclosure includes implementations in which the computing platform(s) 402, the remote platform(s) 404, and/or the external resources 428 may be operatively linked via some other communication media.

A given remote platform 404 may include client computing devices, which may each include one or more processors configured to execute computer program modules. The computer program modules may be configured to enable an expert or user associated with the given remote platform 404 to interface with the system 400 and/or external resources 428, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a NetBook, a Smartphone, a gaming console, and/or other computing platforms. The external resources 428 may include sources of information outside of the system 400, external entities participating with the system 400, and/or other resources. For example, the external resources 428 may include externally designed blockchain elements and/or applications designed by third parties. In some implementations, some or all of the functionality attributed herein to the external resources 428 may be provided by resources included in system 400.

Computing platform(s) 402 may include the electronic storage 426, a processor such as the processors 430, and/or other components. The computing platform(s) 402 may include communication lines, or ports to enable the exchange of information with a network and/or other computing platforms. Illustration of the computing platform(s) 402 in FIG. 4 is not intended to be limiting. The computing platform(s) 402 may include a plurality of hardware, software, and/or firmware components operating together to provide the functionality attributed herein to the computing platform(s) 402. For example, the computing platform(s) 402 may be implemented by a cloud of computing platforms operating together as the computing platform(s) 402.

Electronic storage 426 may include non-transitory storage media that electronically stores information. The electronic storage media of the electronic storage 426 may include one or both of system storage that is provided integrally (i.e., substantially non-removable) with computing platform(s) 402 and/or removable storage that is removably connectable to computing platform(s) 402 via, for example, a port (for example, a USB port, a firewire port, etc.) or a drive (for example, a disk drive, etc.). Electronic storage 426 may include one or more of optically readable storage media (for example, optical disks, etc.), magnetically readable storage media (for example, magnetic tape, magnetic hard drive, floppy drive, etc.), electrical charge-based storage media (for example, EEPROM, RAM, etc.), solid-state storage media (for example, flash drive, etc.), and/or other electronically readable storage media. Electronic storage 426 may include one or more virtual storage resources (for example, cloud storage, a virtual private network, and/or other virtual storage resources). Electronic storage 426 may store software algorithms, information determined by the processors 430, information received from computing platform(s) 402, information received from the remote platform(s) 404, and/or other information that enables the computing platform(s) 402 to function as described herein.

Processor(s) 430 may be configured to provide information processing capabilities in computing platform(s) 402. As such, processor(s) 430 may include one or more of a digital processor, an analog processor, a digital circuit designed to process information, an analog circuit designed to process information, a state machine, and/or other mechanisms for electronically processing information. Although processor(s) 430 is shown in FIG. 4 as a single entity, this is for illustrative purposes only. In some implementations, processor(s) 430 may include a plurality of processing units. These processing units may be physically located within the same device, or processor(s) 430 may represent processing functionality of a plurality of devices operating in coordination. Processor(s) 430 may be configured to execute modules 408, 410, 412, 414, 416, 418, and/or 420, and/or other modules. Processor(s) 430 may be configured to execute modules 408, 410, 412, 414, 416, 418, and/or 420, and/or other modules by software; hardware; firmware; some combination of software, hardware, and/or firmware; and/or other mechanisms for configuring processing capabilities on processor(s) 430. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408, 410, 412, 414, 416, 418, and/or 420 are illustrated in FIG. 4 as being implemented within a single processing unit, in implementations in which processor(s) 430 includes multiple processing units, one or more of modules 408, 410, 412, 414, 416, 418, and/or 420 may be implemented remotely from the other modules. The description of the functionality provided by the different modules 408, 410, 412, 414, 416, 418, and/or 420 described below is for illustrative purposes, and is not intended to be limiting, as any of modules 408, 410, 412, 414, 416, 418, and/or 420 may provide more or less functionality than is described. For example, one or more of modules 408, 410, 412, 414, 416, 418, and/or 420 may be eliminated, and some or all of its functionality may be provided by other ones of modules 408, 410, 412, 414, 416, 418, and/or 420. As another example, processor(s) 430 may be configured to execute one or more additional modules that may perform some or all of the functionality attributed below to one of modules 408, 410, 412, 414, 416, 418, and/or 420.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

### Secure Comparison Process

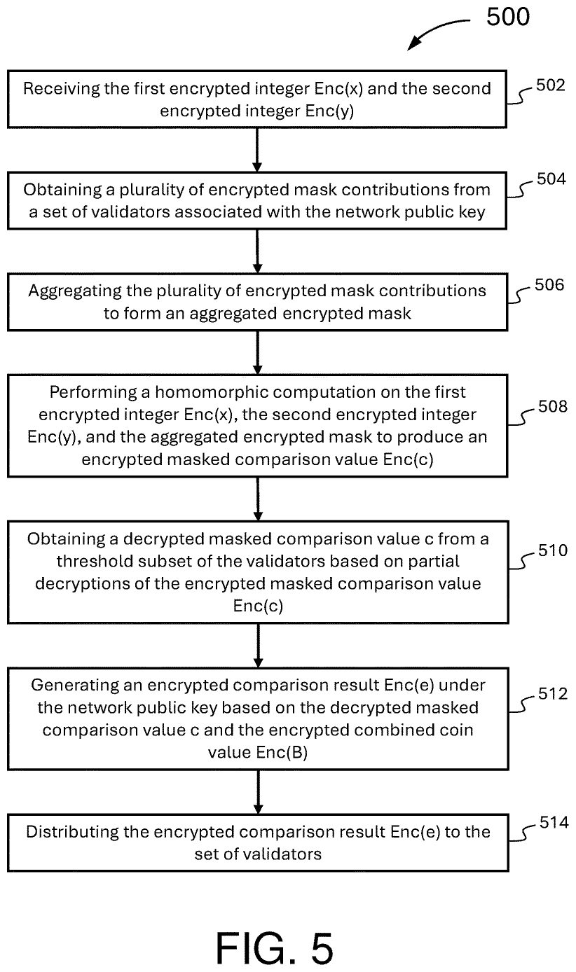

FIG. 5 illustrates a flowchart of an exemplary computer-implemented secure comparison process 500 for performing confidential computation on encrypted data, according to some embodiments. In some embodiments, the secure comparison process 500 is performed in a stateful cryptographic environment in which encrypted state elements are maintained under a network public key. The process may be executed by a set of validators associated with the network public key, where each validator holds a secret-key share corresponding to the network public key and participates in threshold decryption operations. Process 500 compares a first encrypted integer Enc(x) and a second encrypted integer Enc(y) and generates an encrypted comparison result Enc(e) that remains encrypted under the same network public key.

At operation 502, process 500 begins by receiving the first encrypted integer Enc(x) and the second encrypted integer Enc(y), each encrypted under the network public key. The encrypted integers may be received from users, smart contracts, client devices, or other components of a distributed system, such as a blockchain network. Because the encrypted integers remain under the network public key throughout the process, the resulting encrypted comparison output can be directly reused in later homomorphic operations without resharing or re-encryption.

At operation 504, process 500 includes obtaining a plurality of encrypted mask contributions from a set of validators associated with the network public key. Each encrypted mask contribution is generated independently by a respective validator. In some embodiments, each validator samples three values: a coin bᵢ∈{−1, +1}, a first obfuscating number rᵢ, and a second obfuscating number r′ᵢ. Each validator encrypts these values under the network public key to generate an encrypted mask contribution including Enc(bᵢ), Enc(rᵢ), and Enc(r′ᵢ). Because the mask contributions are independent of the particular comparison inputs (i.e., x and y), the encrypted mask contributions may be generated in advance, precomputed by the validators, and stored before receipt of Enc(x) and Enc(y) for later use in a comparison operation.

At operation 506, process 500 includes aggregating the plurality of encrypted mask contributions to form an aggregated encrypted mask including an encrypted combined coin value Enc(B), a first encrypted combined obfuscating value Enc(R) and a second combined obfuscating value Enc(R′). The aggregation may be performed by a designated leader validator or, in other embodiments, locally by multiple validators in a peer-to-peer configuration. The encrypted combined coin value Enc(B) is generated by multiplicatively combining the encrypted coin values from the validators, as defined in Equation (1):

Enc(b)=Enc(b₀)×Enc(b₁)× . . . ×Enc(bᵢ) Equation (1)
where the underlying combined coin is B=b₀×b₁× . . . ×bᵢ and therefore B∈{−1, +1}.

The first encrypted combined obfuscating value Enc(R) is generated by additively combining the first encrypted obfuscating values, as defined in Equation (2):

Enc(R)=Enc(r_0)+Enc(r_1)+ . . . +Enc(r_i) Equation (2)
where the underlying first encrypted combined obfuscating value is R=r₀+r₁+ . . . +rᵢ

A second encrypted combined obfuscating value Enc(R′) is generated by additively combining the second encrypted obfuscating values, as defined in Equation (3):

Enc(R′)=Enc(r′_0)+Enc(r′_1)+ . . . +Enc(r′_i) Equation (3)
where the underlying second encrypted combined obfuscating value is R′=r′₀+r′₁+ . . . +r′ᵢ.

According to embodiments, the aggregation is enabled using a fully homomorphic encryption scheme under the network public key, such that both homomorphic multiplication and homomorphic addition are supported on ciphertexts. This permits local aggregation of the encrypted mask contributions without exposing the underlying mask values in plaintext.

At operation 508, process 500 includes performing a homomorphic computation on the first encrypted integer Enc(x), the second encrypted integer Enc(y), and the aggregated encrypted mask to produce an encrypted masked comparison value Enc(c). The homomorphic computation may include computing a shifted encrypted difference Enc(Δ) between the second encrypted integer. The shifted encrypted difference Enc(Δ) can be expressed as:

Enc(Δ)=[2×(enc(y)−Enc(x))]+Enc(1) Equation (4)

The homomorphic computation may further include computing the encrypted masked comparison value Enc(c) based on the shifted encrypted difference Enc(Δ), the first encrypted combined obfuscating value Enc(R), the second encrypted combined obfuscating value Enc(R′), and the encrypted combined coin value Enc(B). The encrypted masked comparison value Enc(c) can be expressed as:

Enc(c)=[enc(b)×Enc(r)×Enc(Δ)]−Enc(r′) Equation (5)

In this manner, the first combined obfuscating value R provides multiplicative masking, the second combined obfuscating value R′ provides additive masking, and the combined coin B provides sign masking. As a result, the encrypted masked comparison value conceals both the magnitude and sign of the underlying comparison quantity while preserving sufficient structure for later recovery of the comparison outcome.

In some embodiments, process 500 is implemented using ciphertexts of a fully homomorphic encryption scheme under the network public key. The first encrypted integer Enc(x), the second encrypted integer Enc(y), and the plurality of encrypted mask contributions may all be ciphertexts of the fully homomorphic encryption scheme. Because the scheme supports both homomorphic addition and homomorphic multiplication, the process can homomorphically aggregate mask contributions and compute the encrypted masked comparison value using the same cryptographic framework.

At operation 510, process 500 includes obtaining a decrypted masked comparison value c from a threshold subset of the validators based on partial decryptions of the encrypted masked comparison value Enc(c). In a leader-based embodiment, a designated leader validator receives, from the threshold subset of validators, partial decryptions of Enc(c) and combines those partial decryptions to obtain the decrypted masked comparison value c. Because each validator holds a secret-key share corresponding to the network public key, no single validator is required to decrypt the encrypted masked comparison value independently. Rather, threshold decryption is achieved through combination of partial decryptions from the threshold subset. In some embodiments, the threshold subset is a t-of-N subset of validators, and the comparison process proceeds once the requisite number of validator contributions has been received.

At operation 512, after the decrypted masked comparison value c is obtained, process 500 includes generating an encrypted comparison result Enc(e) under the network public key based on the decrypted masked comparison value c and the encrypted combined coin value Enc(B). In some embodiments, an intermediate encrypted value Enc(d) is selected based on the sign of the decrypted masked comparison value c. In some embodiments, the intermediate encrypted value Enc(d) is selected from a two-element set consisting of the encrypted combined coin value Enc(B) and an additive inverse of the encrypted combined coin value Enc(−B). If the decrypted masked comparison value c is greater than zero (i.e., c>0), the intermediate encrypted value Enc(d) is set equal to the encrypted combined coin value Enc(B) (i.e., Enc(d)=Enc(B)). If the decrypted masked comparison value c is less than zero (i.e., c<0), the intermediate encrypted value Enc(d) is set to equal to the additive inverse of the encrypted combined coin value Enc(B) (i.e., Enc(d)=−Enc(B)). The encrypted comparison result can then be computed as:

Enc(e)=(1+Enc(d))/2 Equation (6)

In some embodiments, the encrypted comparison result Enc(e) is an encrypted Boolean value representing one of two mutually exclusive comparison outcomes—whether y≥x or y<x. Because the encrypted comparison result Enc(e) remains encrypted under the same network public key as the input integers and mask contributions, the encrypted comparison result Enc(e) may be distributed to the validators and reused in subsequent encrypted computations as part of encrypted system state.

Additionally, because the encrypted masked comparison value Enc(c) is defined in terms of a shifted difference value (that is, Δ=2(y−x)+1) rather than the raw difference (that is, (y−x)), the comparison protocol is able to compute the encrypted Boolean result corresponding to y≥x (that is, Enc([y≥x])) directly, while eliminating the ambiguous zero case that would otherwise arise when x=y because Δ is strictly positive when y≥x and strictly negative when y<x. In some embodiments, the masking operation is further structured so that the random sign term also affects the offset in a manner that causes the decrypted masked comparison value c to be statistically independent of the sign of the underlying comparison expression. As a result, a party that obtains the plaintext, decrypted masked comparison value c through threshold decryption does not learn from the decrypted masked comparison value c alone whether y≥x or y<x.

At operation 514, process 500 includes distributing the encrypted comparison result Enc(e) to the set of validators.

According to some embodiments, process 500 uses a constant number of communication rounds regardless of the bit-length of the received encrypted integers. For example, one communication round may be used for transmission of encrypted mask contributions, and another communication round may be used for threshold decryption via validator partial decryptions. The number of communication rounds therefore does not scale with the bit-length of the encrypted integers being compared. In some embodiments, this constant-round behavior is enabled by using a fully homomorphic encryption scheme that operates on integer values rather than requiring binary decomposition of the encrypted integers.

In some implementations, one or more operation blocks of FIG. 5 may be performed by a processor circuit executing instructions stored in a memory circuit, in a client device, a remote server or a database, communicatively coupled through a network (for example, processors 205, memories 220, participant 110, participant 130, database(s) 152, and network 150).

Although FIG. 5 shows example blocks of method 500, in some implementations, the method 500 may include additional blocks, fewer blocks, different blocks, or differently arranged blocks than those depicted in FIG. 5.

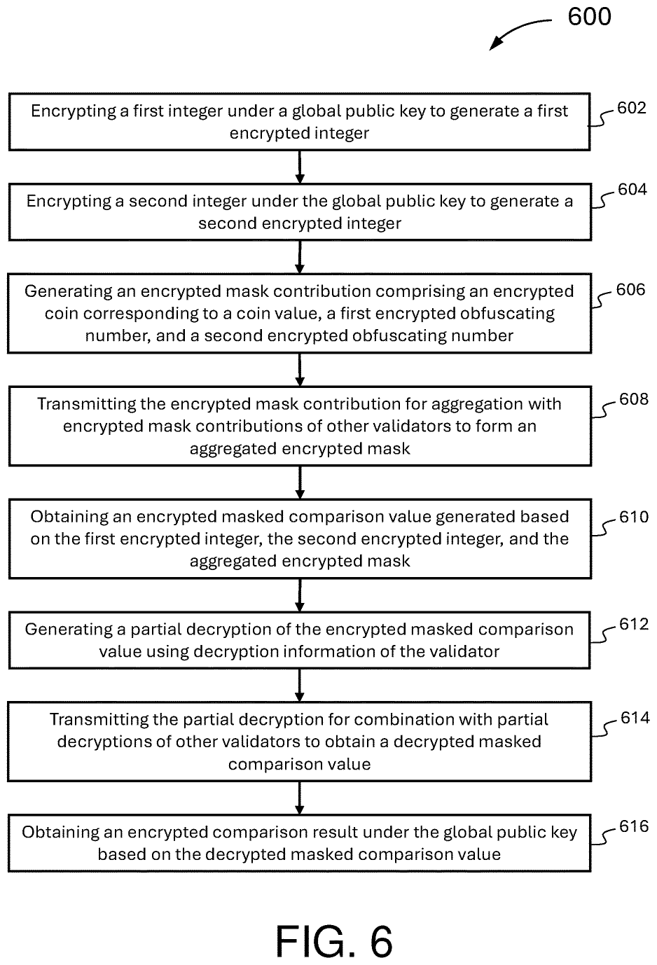

FIG. 6 illustrates a method performed by a validator in a stateful cryptographic environment for securely comparing integers, according to some embodiments.

At operation 602, method 600 includes encrypting a first integer under a global public key to generate a first encrypted integer.

At operation 604, method 600 includes encrypting a second integer under the global public key to generate a second encrypted integer.

At operation 606, method 600 includes generating an encrypted mask contribution comprising an encrypted coin corresponding to a coin value, a first encrypted obfuscating number, and a second encrypted obfuscating number.

According to some embodiments, generating the encrypted mask contribution can include sampling the coin value from the set consisting of negative one and positive one, sampling a first obfuscating value and a second obfuscating value, and encrypting the coin value, the first obfuscating value, and the second obfuscating value under the global public key. In some implementations, the encrypted mask contribution is generated before receipt of the first encrypted integer and the second encrypted integer.

At operation 608, method 600 includes transmitting the encrypted mask contribution for aggregation with encrypted mask contributions of other validators to form an aggregated encrypted mask comprising an encrypted combined coin value, a first encrypted combined obfuscating value, and a second encrypted combined obfuscating value. In some embodiments, the validator transmits the encrypted mask contribution to a designated leader validator that aggregates encrypted mask contributions from other validators.

At operation 610, method 600 includes obtaining an encrypted masked comparison value generated based on the first encrypted integer, the second encrypted integer, and the aggregated encrypted mask. In some embodiments, the encrypted masked comparison value is obtained from the designated leader validator after the designated leader validator performs a homomorphic computation using the aggregated encrypted mask.

At operation 612, method 600 includes generating a partial decryption of the encrypted masked comparison value using decryption information of the validator. According to some embodiments, generating the partial decryption can further include applying, by the validator, decryption information associated with the validator to the encrypted masked comparison value to produce a decryption share.

At operation 614, method 600 includes transmitting the partial decryption for combination with partial decryptions of other validators to obtain a decrypted masked comparison value corresponding to a masked difference between the first integer and the second integer. The decrypted masked comparison value can be obtained by combining partial decryptions from a threshold subset of validators.

At operation 616, method 600 includes obtaining an encrypted comparison result under the global public key based on the decrypted masked comparison value.

In some implementations, one or more operation blocks of FIG. 6 may be performed by a processor circuit executing instructions stored in a memory circuit, in a client device, a remote server or a database, communicatively coupled through a network (for example, processors 205, memories 220, participant 110, participant 130, database(s) 152, and network 150).

Although FIG. 6 shows example blocks of method 600, in some implementations, the method 600 may include additional blocks, fewer blocks, different blocks, or differently arranged blocks than those depicted in FIG. 6.

### Hardware Overview

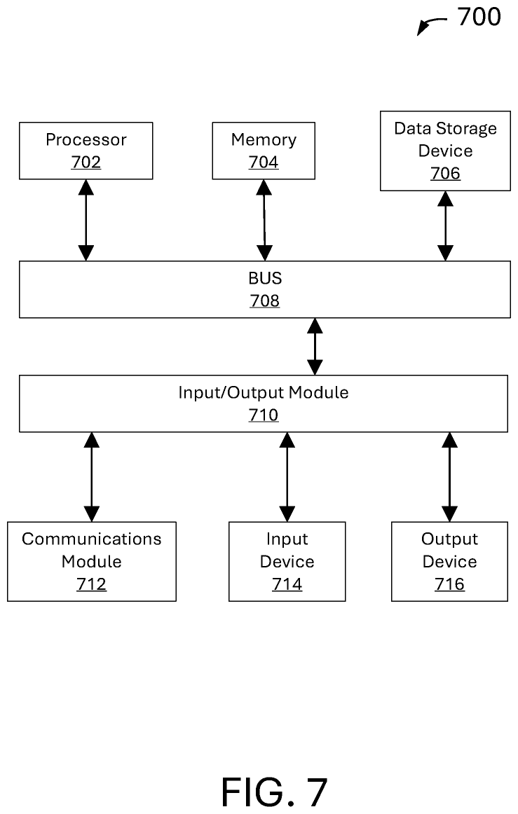

FIG. 7 is a block diagram illustrating an exemplary computer system 700 with which aspects of the subject technology can be implemented. In certain aspects, the computer system 700 may be implemented using hardware or a combination of software and hardware, either in a dedicated server, integrated into another entity, or distributed across multiple entities.

The computer system 700 (for example, server and/or participant) includes a bus 708 or other communication mechanism for communicating information, and a processor 702 (for example, processors 205) coupled with the bus 708 for processing information. By way of example, the computer system 700 may be implemented with one or more processors 702. Each of the one or more processors 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The computer system 700 can include, in addition to hardware, code that creates an execution environment for the computer program in question, for example, code that constitutes processor firmware, a protocol stack, a database management system, an operating system, or a combination of one or more of them stored in an included memory 704, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. Processor 702 and memory 704 can be supplemented by, or incorporated in, special purpose logic circuitry.

The instructions may be stored in memory 704 and implemented in one or more computer program products, i.e., one or more modules of computer program instructions encoded on a computer-readable medium for execution by, or to control the operation of, the computer system 700, and according to any method well-known to those of skill in the art, including, but not limited to, computer languages such as data-oriented languages (for example, SQL, dBase), system languages (for example, C, Objective-C, C++, Assembly), architectural languages (for example, Java, .NET), and application languages (for example, PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by the processor 702.

A computer program as discussed herein does not necessarily correspond to a file in a file system. A program can be stored in a portion of a file that holds other programs or data (for example, one or more scripts stored in a markup language document), in a single file dedicated to the program in question, or in multiple coordinated files (for example, files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 700 further includes a data storage device 706 such as a magnetic disk or optical disk, coupled to bus 708 for storing information and instructions. The computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, the input/output module 710 is configured to connect to a plurality of devices, such as an input device 714 and/or an output device 716. Exemplary input devices 714 include a keyboard and a pointing device, for example, a mouse or a trackball, by which a user can provide input to the computer system 700. Other kinds of input devices can be used to provide for interaction with a user as well, such as a tactile input device, visual input device, audio input device, or brain-computer interface device. For example, feedback provided to the user can be any form of sensory feedback, for example, visual feedback, auditory feedback, or tactile feedback, and input from the user can be received in any form, including acoustic, speech, tactile, or brain wave input. Exemplary output devices 716 include display devices such as an LCD (liquid crystal display) monitor, for displaying information to the user.

According to one aspect of the present disclosure, the above-described systems can be implemented using a computer system 700 in response to the processor 702 executing one or more sequences of one or more instructions contained in the memory 704. Such instructions may be read into memory 704 from another machine-readable medium, such as data storage device 706. Execution of the sequences of instructions contained in the main memory 704 causes the processor 702 to perform the process steps described herein. One or more processors in a multi-processing arrangement may also be employed to execute the sequences of instructions contained in the memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, for example, such as a data server, or that includes a middleware component, for example, an application server, or that includes a front end component, for example, a client computer having a graphical user interface or a Web browser through which a user can interact with an implementation of the subject matter described in this specification, or any combination of one or more such back end, middleware, or front end components. The components of the system can be interconnected by any form or medium of digital data communication, for example, a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

The computer system 700 can include clients and servers. A client and server are generally remote from each other and typically interact through a communication network. The relationship of client and server arises by virtue of computer programs running on the respective computers and having a client-server relationship to each other. The computer system 700 can be, for example, and without limitation, a desktop computer, laptop computer, or tablet computer. The computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to the processor 702 for execution. Such a medium may take many forms, including, but not limited to, non-volatile media, volatile media, and transmission media. Non-volatile media include, for example, optical or magnetic disks, such as the data storage device 706. Volatile media include dynamic memory, such as the memory 704. Transmission media include coaxial cables, copper wire, and fiber optics, including the wires that comprise the bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (for example, one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (for example, DVD-ROM, dual-layer DVD-ROM), a variety of recordable/rewritable DVDs (for example, DVD-RAM, DVD-RW, DVD+RW, etc.), flash memory (for example, SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In some embodiments, the computer-readable media is non-transitory computer-readable media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub programs, or portions of code). A computer program can be deployed to be executed on one computer or on multiple computers that are located at one site or distributed across multiple sites and interconnected by a communication network. While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

It should be understood that the original applicant herein determines which technologies to use and/or productize based on their usefulness and relevance in a constantly evolving field, and what is best for it and its users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize user privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the user's privacy settings or preferences. It should also be understood that the original applicant intends that the systems and methods described herein, if implemented or used by other entities, be in compliance with privacy policies and practices that are consistent with its objective to respect the user's privacy.

1. A method for secure comparison of encrypted integers in a stateful cryptographic environment, the method comprising:
receiving a first encrypted integer and a second encrypted integer, each encrypted under a network public key;
obtaining a plurality of encrypted mask contributions from a set of validators associated with the network public key, wherein each encrypted mask contribution is generated independently by a validator from the set of validators;
aggregating the plurality of encrypted mask contributions to form an aggregated encrypted mask comprising an encrypted combined coin value and encrypted combined obfuscating values;
performing a homomorphic computation on the first encrypted integer, the second encrypted integer, and the aggregated encrypted mask to produce an encrypted masked comparison value;
obtaining, from a threshold subset of the set of validators, a decrypted masked comparison value based on partial decryptions of the encrypted masked comparison value;
generating an encrypted comparison result, encrypted under the network public key, based on the decrypted masked comparison value and the encrypted combined coin value; and
distributing the encrypted comparison result to the set of validators.

2. The method of claim 1, further comprising:
generating an encrypted mask contribution comprising an encrypted coin sampled from a set consisting of negative one and positive one, a first encrypted obfuscating number, and a second encrypted obfuscating number.

3. The method of claim 1, further comprising:
generating the encrypted combined coin value by multiplicatively combining encrypted coin values from the plurality of encrypted mask contributions generated by validators in the set of validators;
generating a first encrypted combined obfuscating value by additively combining first encrypted obfuscating values from the plurality of encrypted mask contributions of the validators in the set of validators; and
generating a second encrypted combined obfuscating value by additively combining second encrypted obfuscating values from the plurality of encrypted mask contributions of the validators in the set of validators.

4. The method of claim 1, wherein performing the homomorphic computation comprises:
computing a shifted encrypted difference between the second encrypted integer and the first encrypted integer;
multiplying the shifted encrypted difference by a first encrypted combined obfuscating value and the encrypted combined coin value; and
subtracting a second encrypted combined obfuscating value from a result of the multiplication to produce the encrypted masked comparison value.

5. The method of claim 1, wherein generating the encrypted comparison result comprises:
setting an intermediate encrypted value to the encrypted combined coin value when the decrypted masked comparison value is greater than zero;
setting the intermediate encrypted value to an additive inverse of the encrypted combined coin value when the decrypted masked comparison value is less than zero; and
computing the encrypted comparison result based on the intermediate encrypted value.

6. The method of claim 1, wherein the plurality of encrypted mask contributions are computed and stored by validators in the set of validators before receipt of the first encrypted integer and the second encrypted integer.

7. The method of claim 1, wherein the homomorphic computation supports both homomorphic addition and homomorphic multiplication operations on ciphertexts encrypted under the network public key.

8. The method of claim 1, wherein the first encrypted integer, the second encrypted integer, and the plurality of encrypted mask contributions are ciphertexts of a fully homomorphic encryption scheme under the network public key.

9. The method of claim 1, wherein each validator in the set of validators holds a secret-key share corresponding to the network public key.

10. The method of claim 1, wherein obtaining encrypted comparison results requires a constant number of communication rounds regardless of a bit-length of received encrypted integers.

11. The method of claim 1, wherein obtaining the decrypted masked comparison value comprises: receiving, by a designated leader validator and from the threshold subset of the set of validators, partial decryptions of the encrypted masked comparison value; and combining, by the designated leader validator, the partial decryptions to obtain the decrypted masked comparison value.

12. A system, comprising:
one or more processors; and
a memory comprising instructions stored thereon, which when executed by the one or more processors, causes the one or more processors to:
receive a first encrypted integer and a second encrypted integer, each encrypted under a network public key;
obtain a plurality of encrypted mask contributions from a set of validators associated with the network public key, wherein each encrypted mask contribution is generated independently by a validator from the set of validators;
aggregate the plurality of encrypted mask contributions to form an aggregated encrypted mask comprising an encrypted combined coin value and encrypted combined obfuscating values;
perform a homomorphic computation on the first encrypted integer, the second encrypted integer, and the aggregated encrypted mask to produce an encrypted masked comparison value;
obtain, from a threshold subset of the set of validators, a decrypted masked comparison value based on partial decryptions of the encrypted masked comparison value;
generate an encrypted comparison result, encrypted under the network public key, based on the decrypted masked comparison value and the encrypted combined coin value; and
distribute the encrypted comparison result to the set of validators.

13. The system of claim 12, wherein the instructions, when executed by at least one of the one or more processors, further causes the system to:
generate an encrypted mask contribution comprising an encrypted coin sampled from a set consisting of negative one and positive one, a first encrypted obfuscating number, and a second encrypted obfuscating number.

14. The system of claim 12, wherein the instructions, when executed by at least one of the one or more processors, further causes the system to:
generate the encrypted combined coin value by multiplicatively combining encrypted coin values from the plurality of encrypted mask contributions generated by validators in the set of validators;
generate a first encrypted combined obfuscating value by additively combining first encrypted obfuscating values from the plurality of encrypted mask contributions of the validators in the set of validators; and
generate a second encrypted combined obfuscating value by additively combining second encrypted obfuscating values from the plurality of encrypted mask contributions of the validators in the set of validators.

15. The system of claim 12, wherein the instructions, when executed by at least one of the one or more processors, further causes the system to:
compute a shifted encrypted difference between the second encrypted integer and the first encrypted integer;
multiply the shifted encrypted difference by a first encrypted combined obfuscating value and the encrypted combined coin value; and
subtract a second encrypted combined obfuscating value from a result of the multiplication to produce the encrypted masked comparison value.

16. The system of claim 12, wherein the instructions, when executed by at least one of the one or more processors, further causes the system to:
set an intermediate encrypted value to the encrypted combined coin value when the decrypted masked comparison value is greater than zero;
set the intermediate encrypted value to an additive inverse of the encrypted combined coin value when the decrypted masked comparison value is less than zero; and
compute the encrypted comparison result based on the intermediate encrypted value.

17. The system of claim 12, wherein the homomorphic computation supports both homomorphic addition and homomorphic multiplication operations on ciphertexts encrypted under the network public key.

18. The system of claim 12, wherein the instructions, when executed by at least one of the one or more processors, further causes the system to:
receive, by a designated leader validator and from the threshold subset of the set of validators, partial decryptions of the encrypted masked comparison value; and
combine, by the designated leader validator, the partial decryptions to obtain the decrypted masked comparison value.

19. A non-transitory computer-readable medium storing a program, which when executed by a computer, configures the computer to:
receive a first encrypted integer and a second encrypted integer, each encrypted under a network public key;
obtain a plurality of encrypted mask contributions from a set of validators associated with the network public key, wherein each encrypted mask contribution is generated independently by a validator from the set of validators;
aggregate the plurality of encrypted mask contributions to form an aggregated encrypted mask comprising an encrypted combined coin value and encrypted combined obfuscating values;
perform a homomorphic computation on the first encrypted integer, the second encrypted integer, and the aggregated encrypted mask to produce an encrypted masked comparison value;
obtain, from a threshold subset of the set of validators, a decrypted masked comparison value based on partial decryptions of the encrypted masked comparison value;
generate an encrypted comparison result, encrypted under the network public key, based on the decrypted masked comparison value and the encrypted combined coin value; and
distribute the encrypted comparison result to the set of validators.

20. The non-transitory computer-readable medium of claim 19, wherein the program, when executed by the computer, further configures the computer to:
set an intermediate encrypted value to the encrypted combined coin value when the decrypted masked comparison value is greater than zero;
set the intermediate encrypted value to an additive inverse of the encrypted combined coin value when the decrypted masked comparison value is less than zero; and
compute the encrypted comparison result based on the intermediate encrypted value.
